(19) United States
(12) Patent Application Publication
(10) Pub. No.: US 2023/0065355 A1
(43) Pub. Date: Mar. 2, 2023

(54) Systems and Methods for a Control System for a Vehicle

(71) Applicant: Atlis Motor Vehicles, Inc., Mesa, AZ (US)

(72) Inventors: Benoit le Bourgeois, Mesa, AZ (US); Sean Lamont, Fort Myers, FL (US)

(73) Assignee: Atlis Motor Vehicles, Inc., Mesa, AZ (US)

(21) Appl. No.: 17/894,279

(22) Filed: Aug. 24, 2022

Related U.S. Application Data
(60) Provisional application No. 63/236,483, filed on Aug. 24, 2021.

(51) Int. Cl. B60K 35/00; G06F 3/04817; G06F 3/0488

(52) U.S. Cl. CPC B60K 35/00; G06F 3/04817; G06F 3/0488; B60K 2370/119; B60K 2370/1438; B60K 2370/195

(57) ABSTRACT

The control system for a vehicle includes processing circuit, and memory and a touchscreen. The processing circuit detects the characteristics of contact (e.g., touch) between the user's hand and/or an object and the touch-sensitive surface of the touchscreen. Responsive to the touch, the control system may present touch controls of a particular class on the touchscreen, establish sub-areas of the touchscreen, and/or control the operation of a system of the vehicle. The touch controls displayed on the touchscreen may perform the function of a dynamic touch control in that the graphic of the icon of the touch control may change to provide status regarding the operation of the system related to the touch control.

### BACKGROUND

Embodiments of the present invention relate to a control system for a vehicle.

Vehicle drivers would benefit from control system that includes a touch-sensitive surface for displaying touch controls (e.g., icons) in accordance with frequency of use (e.g., often, regularly, rarely) and the position of the user in the vehicle (e.g., driver side, passenger side). Further, benefit may be accrued by presenting information in accordance with the type of gesture (e.g., touch) used by the user to touch the touchscreen of the control panel.

### SUMMARY

An example embodiment of the control system according to the present disclosure includes a touchscreen with a touch-sensitive surface that displays touch controls (e.g., icons) for selection by a user (e.g., driver, passenger). In an example embodiment, the touchscreen is positioned between the driver and the passenger to provide access to the touchscreen and the touch controls thereof by both the driver and the passenger. The touch controls displayed on the touch-sensitive surface may be manipulated by the user to control the systems of the vehicle.

The driver and/or the passenger May provide input (e.g., contact, gestures, swipes, touch) to the control system via the touch-sensitive surface of the touchscreen. Input may include taps, presses, long press, short swipes (e.g., strokes, touches), long swipes and so forth. Input by the user may be referred to in general as touch as in touching the touchscreen either manually or with an object. The user may touch the touch-sensitive surface of the touchscreen at any initial location, for any duration of time, in any direction (e.g., left, right, up, down, diagonally) of movement, at any speed of movement, along any distance of movement and cease contact at any last location of contact. One touch may be distinguished from another touch by differences in initial location of contact, duration of time, direction, speed, distance and/or last location of contact, which comprise the characteristics of the touch.

Touches of different types, meaning touches having different characteristics as described above, may be used to request that the control system present icons that are used often, regularly, rarely or never and/or icons of a particular class (e.g., control, system, driver, passenger). Further, a touch having specific characteristics may result in displaying touch controls useful only to the driver (e.g., driver class), touch controls useful only to the passenger (e.g., passenger class), or the icons of a particular class of icons.

While an icon is presented on the touch-sensitive surface of the touchscreen, the icon and the touchscreen cooperate with each other to enable the user to select the icon to perform a function by one or more vehicle systems. An icon displayed on the touch-sensitive surface of the touchscreen is referred to as a touch control. The touch control may identify the function of a vehicle system that will be controlled. After selection, the image of a touch control may change to present information regarding the function of the vehicle system related to the touch control. A touch control whose image changes to provide information to a user is referred to herein as a dynamic touch control or a dynamic icon. A dynamic touch control may present information regarding the status of the operation of a vehicle system.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a diagram of the interior of a vehicle that includes the control system according to various aspects of the present disclosure;

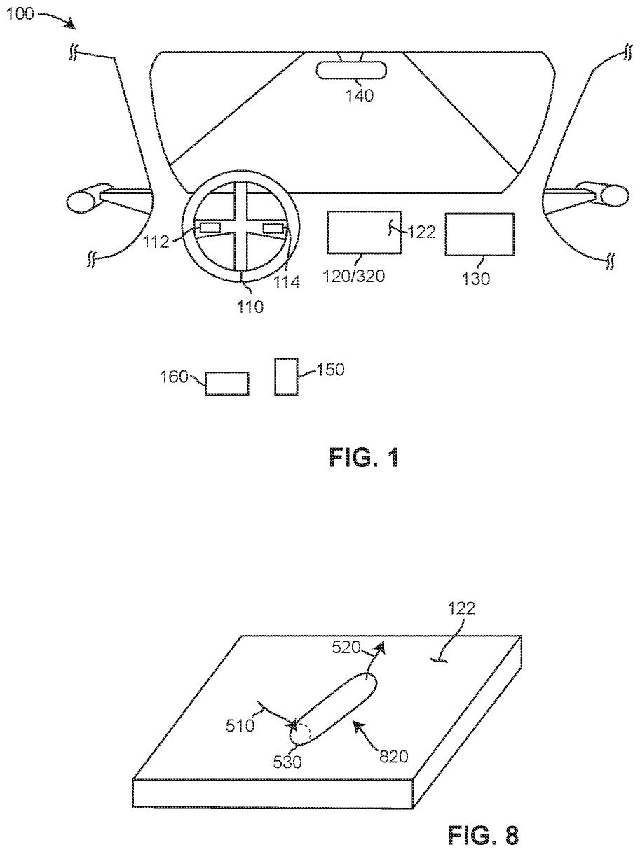

FIG. 2 is a block diagram of a first embodiment of the control system;

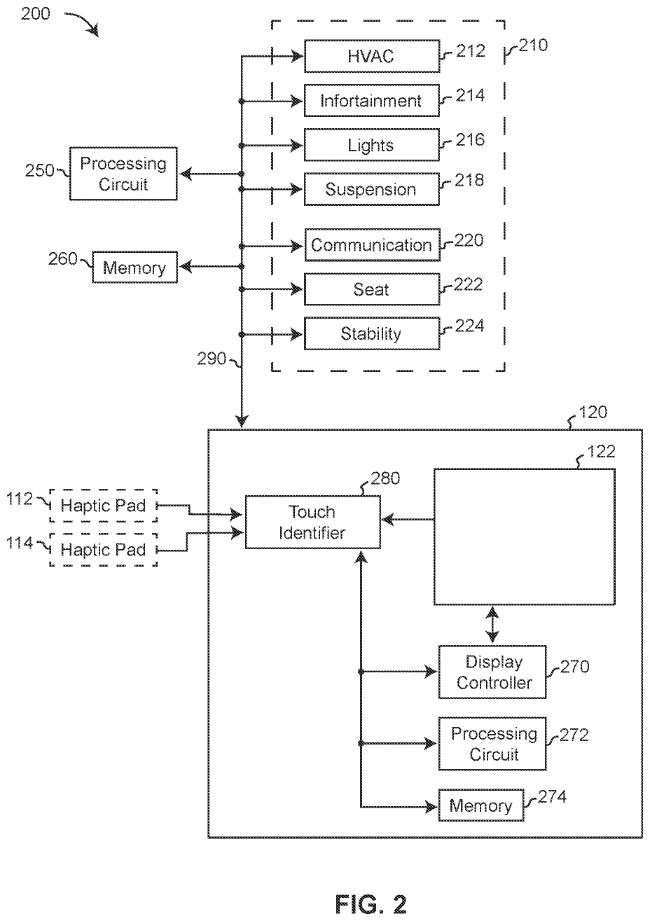

FIG. 3 is a block diagram of a second embodiment of the control system;

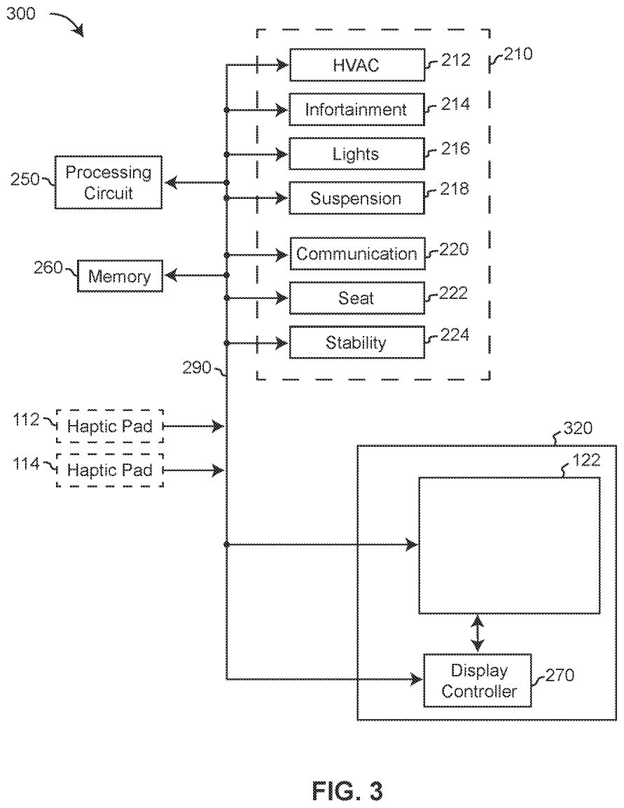

FIG. 4 is a diagram of an example embodiment of data for the control system;

FIGS. 5-9, 10A, 10B and 11 are diagrams of example touch types;

FIGS. 12-13 are diagrams of example touch controls;

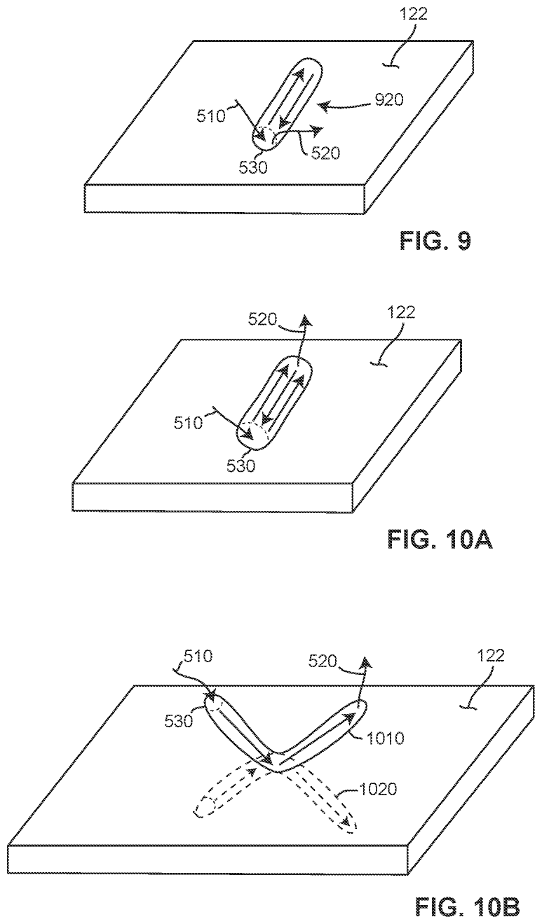

FIG. 14 is a diagram of touch types for establishing or eliminating sub-areas;

FIGS. 15-18 are diagrams of example dynamic touch controls;

FIG. 19 is a diagram of an example display of a startup class of icons;

FIGS. 20-21 are diagrams of a touch type for eliminating sub-areas and presenting one or more classes of icons;

FIG. 22 is a diagram of a touch type for establishing a sub-area and displaying driver class icons;

FIG. 23 is a diagram of a touch type for establishing a sub-area and displaying passenger class icons;

FIG. 24 is a diagram of touch types for displaying icons of various icon classes;

FIG. 25 is a flowchart of an example embodiment of a method of operation of a control system.

### DETAILED DESCRIPTION

### Overview

Vehicle 100, includes steering wheel 110, rear-view mirror 140, brake pedal 160, accelerator pedal 150 and glovebox 130. Touchscreen 120/320 is positioned between the steering wheel 110 and the glovebox 130. The touch-sensitive surface 122 is accessible to the driver and/or the passenger. The touchscreen 120/320 provides an interface for the user (e.g., driver, passenger) to provide input to the control system 200/300 and to receive information from the control system 200/300. Input from the user to the control system 200/300 enables the user to control the operation of the various systems of the vehicle 100. Vehicle 100 may include an electric vehicle. Information from the control system 200/300 provides information to the user regarding the operation of the various systems of the vehicle 100.

The touch-sensitive surface 122 displays information and detects touches by a user. The touchscreen 120/320 may present an icon (e.g., image, graphic, glyph, 1920, 1930, 1940, 1950, 2130, 2140, 2150, 2230, 2232) on a specific portion of the touch-sensitive surface 122. An icon present information to the user that has a meaning in the context of the control system. Generally, the information presented by an icon is related to the operation of a vehicle system. The information presented by an icon may identify a function that may be performed by the vehicle system.

While the icon is presented on the touchscreen 120/320, the icon and the touch-sensitive surface 122 cooperate to form a touch control which may be manually operated by a user for controlling the function indicated by the icon. When the user touches a touch control, either manually (e.g., finger 2020) or using an object (e.g., stylus), the touch-sensitive surface 122 detects the touch and the characteristics (e.g., initial location, duration, direction, speed, distance, last location) of the touch. The touch is correlated to the icon and thereby to the function of the vehicle system represented by the icon. Touching the touch control controls the operation of the function indicated by the icon. The touch controls provide the interface for the user to control the functions of the vehicle.

Icons displayed on the touch-sensitive surface 122 to form touch controls may be grouped into classes of icons. An icon class may include icons that relate to a specific vehicle system or function of the control system. For example, touch controls 1920, 1930, 1940 and 1950 belong to startup class 1910 which are displayed on the touch-sensitive surface 122 when the control system is initiated. The control system 200/300 may be programmed, including by a user, so that any icon may belong to the startup class 1910. Other icon classes include, for example, wiper class 2160, regeneration class 2162, ride control class 2164, and light class 2166. A class of icons may relate to a specific user of the vehicle 100 (e.g., driver, passenger).

Icons may also be grouped (e.g., classified) into classes related to the frequency of use of the icon. Classes of icons related to frequency may include an often-used class, a regularly-use class, a rarely-used class and a never-used class. In an example embodiment, a specific touch type respectively is used to instruct the control system 200/300 to display a specific class of icons.

The touch-sensitive surface 122 may be divided into sub-areas (e.g., 1420, 1430, 1960) for presentation of touch controls. In an example embodiment, a specific type of touch is used to instruct the control system 200/300 to establish or eliminate sub-areas. In another example embodiment, a specific type of touch is used to instruct control system 200/300 to establish a sub area and to display a specific class of icons in the sub-area.

Further, the graphics (e.g., icon) of a touch control may be used to provide information to user regarding the status of the operation of the function represented by the touch control. For example, once the touch control for cellular communication is activated, the graphics of the touch control may be altered to provide information regarding the duration of the cellular call.

### Touch Type

A user may touch the touch-sensitive surface 122 of the touchscreen 120/320 to provide information to the control system 200/300. There may be a variety of touch types as distinguished by the characteristics of the touch. As discussed above, the characteristics of a touch may include an initial location of contact of the touch on the touch-sensitive surface 122, the duration of the touch on the touch-sensitive surface 122, the direction of movement of the touch along (e.g., against) the touch-sensitive surface 122, the speed of movement of the touch along the touch-sensitive surface 122, the distance of movement of the touch along the touch-sensitive surface 122 and the last location of contact of the touch on the touch-sensitive surface 122.

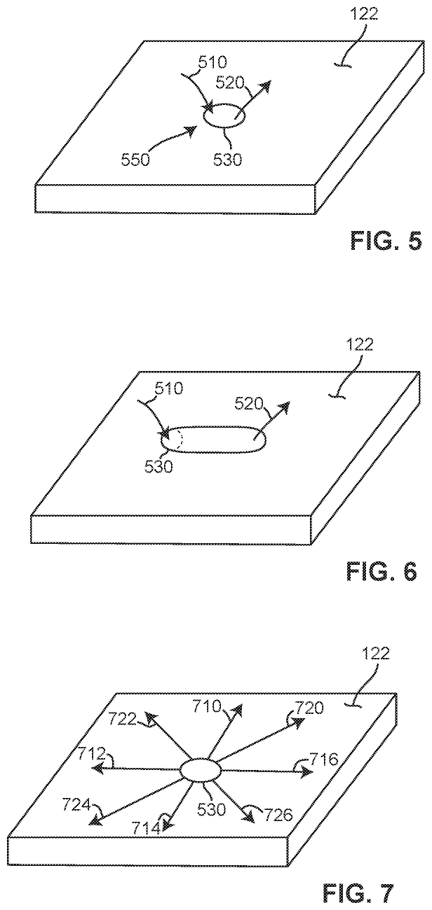

Examples of some possible types of touches are shown in FIGS. 5-11. The arrow 510 represents the path of movement of the finger of the user or an object (e.g., stylus, pen) from a position above (e.g., away from) the touch-sensitive surface 122 as it comes into contact with the touch-sensitive surface 122. The area 530 (e.g., circle) represents the location of initial contact of the finger or object with the touch-sensitive surface 122. The arrow 520 represents the path of movement of the finger or the object from a position of contact with the touch-sensitive surface 122 to a position out of contact (e.g., above, away from) with the touch-sensitive surface 122.

The touch type illustrated in FIG. 5, may be referred to as a short touch (e.g., tap), a medium touch, or a long touch depending on the duration of contact of the finger or object with the touch-sensitive surface 122. In this touch type, the finger or object comes into contact with the touch-sensitive surface 122 along the path 510, initially contacts the touch-sensitive surface 122 at area 530, remains in contact with the touch-sensitive surface 122 in the area 530 for a period of time, and moves along the path 520 to cease contacting the touch-sensitive surface 122.

In this touch type, the initial location of contact is substantially the same as the last location of contact. In other words, there is little or no direction of movement, speed of movement or distance of movement of the touch with respect to the touch-sensitive surface 122. Duration of touch is used to distinguish between a short touch, a medium touch and a long touch. In an example embodiment, the duration of the short touch is between 100 milliseconds and 250 ms. The duration of the medium touch is between 300 ms and 500 ms. The duration of the long touch is greater than 800 ms.

The touch type illustrated in FIGS. 6-8 may be referred to as a swipe or a touch in a particular direction (e.g., up, down, right, left, diagonally). There are many different types of swipes because swipes may be characterized by the duration of the touch, the direction of movement of the touch, the speed of movement of the touch and the distance of movement of the touch. For example, as illustrated in FIG. 6, the finger or object moves along path 510 to come into contact with the touch-sensitive surface 122 at the initial area of contact 530. From the initial area of contact 530, the finger or object moves in a direction, in this case rightward, away from the initial area of contact 530 for either a duration of time or a distance until the finger or object moves along path 520 to cease contacting the touch-sensitive surface 122.

In an example embodiment, swipes or a touch in a particular direction may be characterized by the direction and distance the finger or object moves along the touch-sensitive surface 122 between the initial location in the last location. For example, a short touch in the upward direction (e.g., short-upward touch, short-upward swipe) is a touch that moves in the upward direction a distance of 0.5-1.5 inches. A medium touch in the leftward direction (e.g., medium-leftward touch, medium-leftward swipe) is a touch that moves in the leftward direction a distance of 2.5-3.5 inches. A long touch in the upper-right diagonal direction (e.g., long-upper-right touch/swipe, long-NE touch/swipe) is a touch that moves diagonally in a northeastern direction a distance greater than 5 inches.

In another example embodiment, the distance of a touch may be characterized as a portion of the width of the touch-sensitive surface 122 of the touchscreen 120/320. For example, a short-downward touch is a touch that moves in the downward direction a distance of about ⅕ of the width of the touch-sensitive surface 122. A medium-SW touch is a touch that moves in the southwestern direction a distance of about ⅖ of the width of the touch-sensitive surface 122. A long-SE touch is a touch that moves in the southeastern direction a distance greater than or equal to ⅗ the width of the touch-sensitive surface 122.

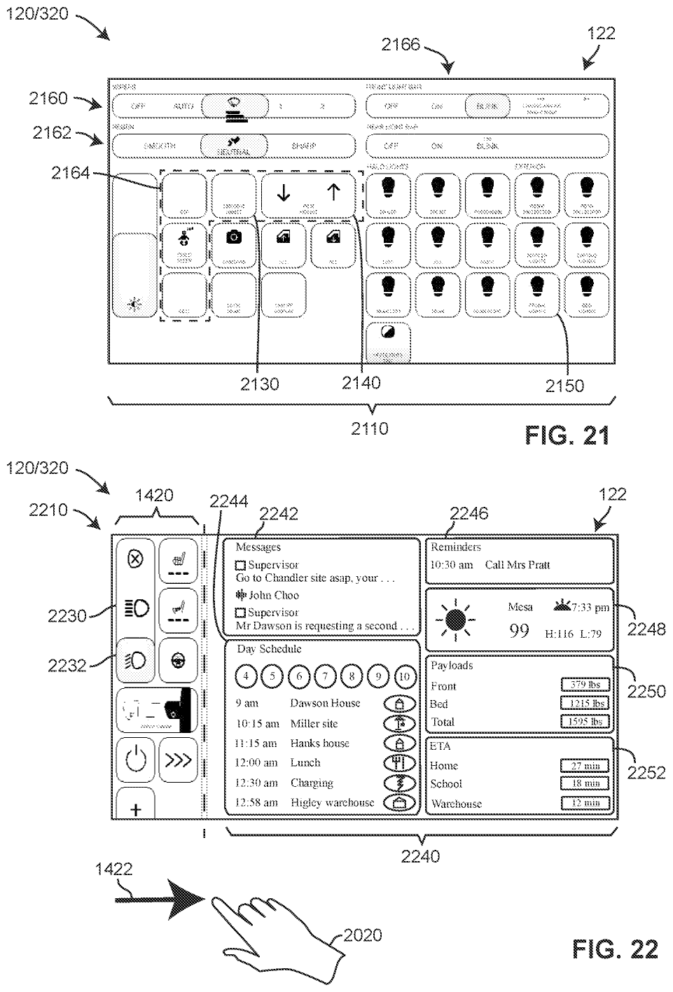

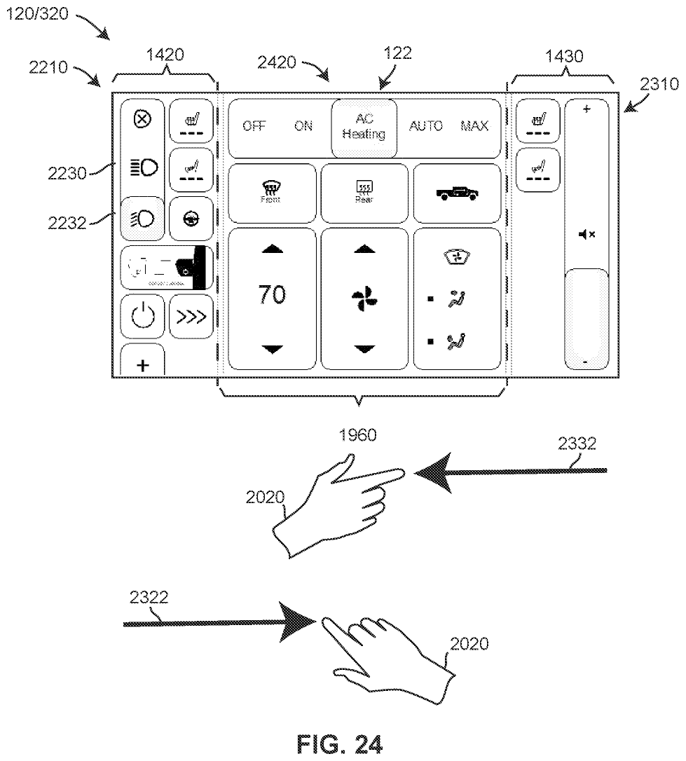

For example, referring to FIG. 22, the touch 1422, a short-rightward touch, begins at or near the left edge of the touch-sensitive surface 122 and ends approximately at the boundary of the sub-area 1420. The distance between the left edge of the touch-sensitive surface 122 and the boundary of the sub-area 1420 is about ⅕ the width of the touch-sensitive surface 122. The touch 2322, the long-rightward touch shown in FIG. 24, begins at or near the left edge of the touch-sensitive surface 122 and ends somewhere just past the middle of touch-sensitive surface 122, which is a distance of about ⅗ of the width of the touch-sensitive surface 122.

The directions illustrated in FIG. 7 identify the directions of movement that may be used to characterize a touch. For example, from initial area of contact 530, the finger or object may move in an upward direction 710 (e.g., North), in a rightward direction 716 (e.g., East), in a downward direction 714 (e.g., South), in a leftward direction 712 (e.g., West), in diagonal direction 720 (e.g., Northeast, upper-right), in diagonal direction 726 (e.g., Southeast, lower-right), in diagonal direction 724 (e.g., Southwest, lower-left), or in diagonal direction 722 (e.g., Northwest, upper-left). Since a short, medium or long touch may be taken in any direction, there are at least 24 different varieties of touches in a direction (e.g., swipes). For example, a medium touch in the diagonal direction 720 is shown in FIG. 8.

The movement of a touch is not limited to movement in a single direction. An out and back touch (e.g., swipe) is shown in FIG. 9. The finger or object comes into contact with the touch-sensitive surface 122 along path 510 and at area 530. The finger or object, while in contact with the touch-sensitive surface 122, moves in an initial direction (e.g., up), momentarily stops moving but remains in contact with the touch-sensitive surface 122, moves in the direction opposite the initial direction until it approximately reaches the initial area of contact 530, then follows path 520 to cease contact with the touch-sensitive surface 122. Because the initial direction may be any direction shown in FIG. 7, there are at least eight different versions of the out and back touch (e.g., up-down, down-up, right-left, left-right, NE-SW, SW-NE, NW-SE, SE-NW). This type of touch may also be characterized by the distance of movement to create additional versions (e.g., short, medium, long) of the out and back swipe.

An out-back-out touch (e.g., swipe) type is illustrated in FIG. 10A. The finger or object comes into initial contact with the touch-sensitive surface 122 along path 510 and at area 530. The finger or object, while maintaining contact with the touch-sensitive surface 122, moves in an initial direction (e.g., up), momentarily stops moving but remains in contact with the touch-sensitive surface 122, moves in the direction opposite the initial direction (e.g., down) until it approximately reaches the initial area of contact 530, momentarily stops but remains in contact with the touch-sensitive surface 122, again moves in the initial direction (e.g., up), then follows path 520 to cease contact with the touch-sensitive surface 122. Variations of initial direction, speed of movement and/or distance of movement may be used to create many different varieties out-back-out touches.

A 90-degree touch type is illustrated in FIG. 10B. The initial direction of movement is in any direction, but the second direction of movement is in a direction that is at an angle of about 90 degrees with respect to the initial direction of movement. The directions of movement, the distance of movement, the speed of movement may be used to distinguish between a variety of 90-degree touches. The 90-degree touch 1010, shown in FIG. 10B, has the shape of the letter V while the 90-degree touch 1020 has the shape of a chevron. Touches may also approximate other letters of the alphabet. A touch that approximates the letter P is shown in FIG. 11.

Each time the finger of the user or an object contacts the touch-sensitive surface 122, the touch may be characterized as described above and identified as being a particular touch type (e.g., short touch, medium touch, long touch, short-rightward touch, long-rightward touch, up-down touch, so forth). The control system 200/300 may take an action in accordance with a specific touch type.

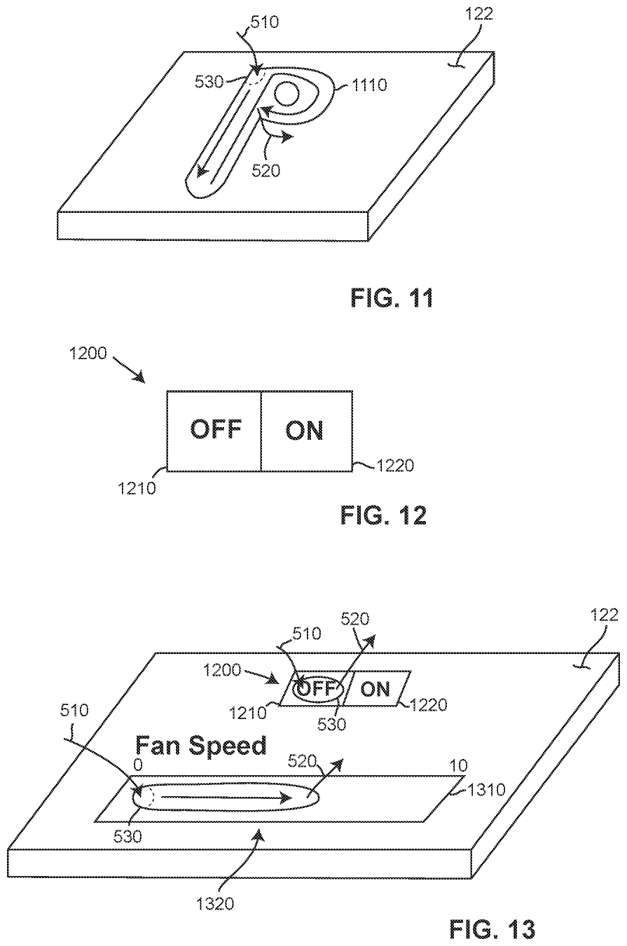

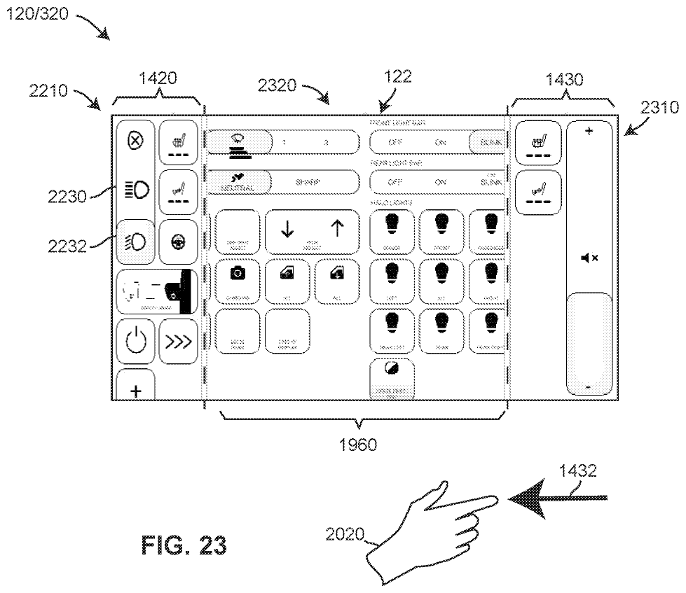

In an example embodiment, touch 1422, which is a short-rightward touch, as best seen in FIGS. 14 and 22, instructs the control system 200/300 to establish sub-area 1420 on touch-sensitive surface 122 and to display the driver class icons 2210 in sub-area 1420. Touch 1432, a short-leftward touch best seen in FIGS. 14 and 23, instructs the control system 200/300 to establish sub-area 1430 on touch-sensitive surface 122 and to display the passenger class icons 2310 in sub-area 1430. The sub-areas 1420 and 1430 may be established at any time by the user performing the touch 1422 and the touch 1432 respectively. The user may program the icons that belong to the driver class icons 2210 or the passenger class icons 2310.

The touch controls and/or information displayed on the touch-sensitive surface 122 in the area that is not sub-area 1420 and/or 1430 is not affected by the touch 1422 and/or touch 1432 but remains the same as that which was being displayed before the touch 1422 or 1432 occurred. For example, referring to FIG. 22, the touch 1422 establishes the sub-area 1420 on the left-hand portion of the touch-sensitive surface 122 and the driver class icons 2210 cover the sub-area 1420; however, the information and touch controls displayed on the remainder of the screen, sub-area 1960, remains unchanged.

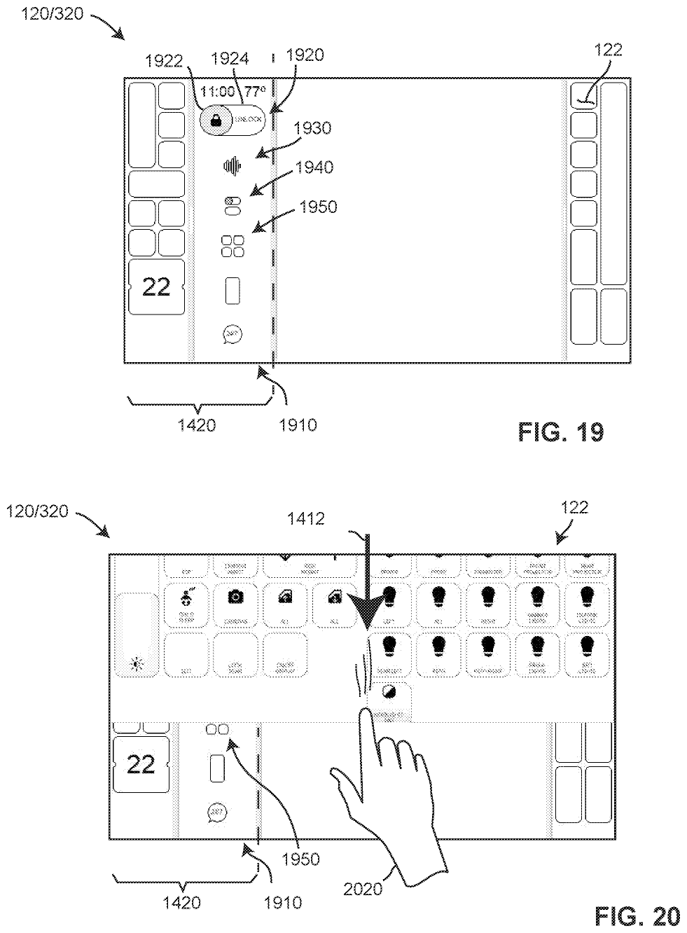

Touch 1412, best seen in FIGS. 14 and 20, is a long-downward touch. Touch 1412 instructs the control system 200/300 to eliminate sub-areas 1420 and 1430 on the touch-sensitive surface 122, if they exist, and to display one or more classes of icons on the full area 2110 of the touch-sensitive surface 122. For example, FIGS. 20-21 show that touch 1412 eliminates the sub-area 1420 to display the wiper 2160, regeneration 2162, ride control 2164 and light 2166 icon classes on the full area 2110 (e.g., full-screen area) of the touch-sensitive surface 122.

### Touch Control

As discussed above, an icon cooperates with the touch-sensitive surface 122 to form a touch control. Just as an icon may be associated with a function of a vehicle system, a touch control may be used to activate or deactivate the operation of the function of the vehicle system.

In an example embodiment, the icon 1200 is a graphic symbol that includes area 1210 and area 1220. The area 1210 includes the word OFF while the area 1220 includes the word ON. The icon 1200 indicates that some type of an operation of a vehicle system may be turned on or off.

When icon 1200 is displayed on the touch-sensitive surface 122, it becomes touch control 1300. The control system 200/300 knows where the icon 1200 is located on the touch-sensitive surface 122 and can detect when the icon is touched. The control system 200/300 can interpret a touch on a touch control to initiate, terminate, or adjust the operation of a vehicle system. In this example, when the icon 1200 is displayed on the touch-sensitive surface 122, it is identified by the control system 200/300 as being the touch control 1300 that controls whether the front defroster of the vehicle 100 is on or off. The user may touch area 1210 or area 1222 of the touch control 1300 to either turn the defroster off or to turn the defroster on respectively.

In an example embodiment, a short touch in the area 1210 is used to turn the defroster off. The characteristics of a short touch are illustrated in FIG. 5 and discussed above. The control system 200/300 detects the short touch in the area 1210 and construes the touch with the information provided by the icon 1200 to know that the touch control to turn the front defroster off has been activated.

In another example embodiment, best seen in FIG. 13, icon 1310, a rectangle oriented horizontally, is displayed on the touch-sensitive surface 122 to form the touch control 1320 to control the speed of a fan. In this embodiment, a medium-rightward touch is used to adjust the fan speed from off (e.g., speed 0) to speed 6. The control system 200/300 detects that the area of initial contact 530 coincides with the icon 1310 and that the touch is in the rightward direction along the icon 1310. So, the icon 1310 in cooperation with the touch-sensitive surface 122 forms the touch control 1320 that is used to control the speed of the fan.

Touch controls may be displayed as images of buttons, sliders and/or checkboxes (e.g., radio button). Touch controls presented as buttons or checkboxes generally may be operated using a short touch, a medium touch or a long touch. Touch controls that are presented as sliders generally may be operated using a touch of a length and a direction that corresponds to the orientation of the slider. For example, a slider displayed horizontally on the touch-sensitive surface 122 maybe operated using a short, medium, or long touch (e.g., swipe) in the rightward or the leftward direction as best shown in FIG. 13. A slider displayed vertically on the touch-sensitive surface 122 may be operated using touch (e.g., swipe) in the upward or downward direction.

### Sub-Areas of the Touch-Sensitive Surface

As briefly discussed above, the touch-sensitive surface 122 of the touchscreen 120/320 may be subdivided into different sub-areas. Icons of different classes may be displayed in the various sub-areas. The control system 200/300 may recognize specific touch types as establishing or eliminating one or more sub-areas.

As discussed above, the touch 1422 instructs the control system 200/300 to establish the sub-area 1420. As further discussed above with respect to touch types, touch 1422 starts as the finger or object approaches the touch-sensitive surface 122 along path 510. The finger or object touches the touch-sensitive surface 122 at the initial location of contact 530 as best seen in FIG. 14. The finger object moves in a rightward direction for a distance that defines the short touch 1422, then the finger object lifts out of contact with the touch-sensitive surface 122 along path 520. The touch 1422 may be performed at any location on the touch-sensitive surface 122 as long as the length requirement of the touch type is met. The control system 200/300 detects the touch type and establishes the sub-area 1420. Icons may be displayed in the sub-area 1420. The icons that were previously displayed on the touch-sensitive surface 122 outside of the sub-area 1420 may remain as previously displayed or they may be reorganized to fit on the area of the touch-sensitive surface 122 that excludes sub-area 1420 (e.g., sub-area 1960).

In an example embodiment, the touch 1432 instructs the control system 200/300 to establish the sub-area 1430. As discussed above with respect to touch types, touch 1432 starts with the finger or object approaching the touch-sensitive surface 122 along path 510. The finger or object makes initial contact with the touch-sensitive surface 122 at location 530. The finger or object moves leftward from the initial location of contact 530 for a distance that defines the touch 1432, then the finger or object lifts from the touch-sensitive surface 122 along path 520. The control system 200/300 detects the touch type and establishes the sub-area 1430. The touch 1432 may be performed at any location on the touch-sensitive surface 122 as long as the length requirement of the touch type is met. Icons may be displayed in the sub-area 1430. The icons that were previously displayed on the touch-sensitive surface 122 outside of the sub-area 1430, and outside of the sub-area 1420 if established, may remain as previously displayed or they may be reorganized to fit on the area of the touch-sensitive surface 122 that excludes the sub-area 1430 and the sub-area 1420 if established.

As discussed above, in an example embodiment, the touch 1422 both establishes the sub-area 1420 and instructs the control system 200/300 to display driver class icons in the sub-area 1420. In an example embodiment, the touch 1432 both establishes the sub-area 1430 and instructs the control system 200/300 to display passenger class icons in the sub-area 1430.

In an example embodiment, touch 1412 eliminates sub-area 1420 and sub-area 1430, if either or both are established, so that icons are displayed on the full area 2110 of the touch-sensitive surface 122. The touch 1412 begins with the finger or object approaching the touch-sensitive surface 122 along path 510. The finger or object makes initial contact with the touch-sensitive surface 122 at initial location 530. The finger or object moves from the initial location of contact 530 in a downward direction a distance that defines the short touch 1412, then the finger or object lifts from the touch-sensitive surface 122 along path 520. The touch 1412 may be performed at any location on the touch-sensitive surface 122 as long as the length requirement of the touch type is met. Icons may be displayed in the full area 2110. The icons that were displayed in the sub-areas 1420 and 1430 are no longer displayed on the touch-sensitive surface 122. The icons that are displayed in the full area 2110 may include icons from one or more icon classes.

In another example embodiment, the touch 2322 in the rightward direction or the touch 2232 in the leftward direction may be used to sequentially display different classes of icons on the touch-sensitive surface 122. In other words, the touch 2322 and the touch 2332 may be used to flip through pages of icons for the various vehicle systems. Referring to FIG. 24, if either the sub-area 1420 or the sub-area 1430 or both are established, the icons will be displayed in the sub-area 1960 of the touch-sensitive surface 122 that does not include the sub-area 1420, the sub-area 1430 or both. If sub-area 1420 and sub-area 1430 are not established, then successive pages of icons are displayed on the full area 2110 of the touch-sensitive surface 122. The icons for one or more vehicle systems 210 (e.g., one or more icon classes) may be displayed on the touch-sensitive surface 122 at the same time.

### Classes of Icons

Icons may be grouped together into classes. In an example embodiment, icons related to a single vehicle system are grouped together into a single class. For example, all icons used to control the operation of the HVAC system 212 are identified as being members of the HVAC class of icons. Each system, including the infotainment system 214, the light system 216, the suspension system 218, the communication system 220, the seats system 222, the stability system 224, and any other system of the vehicle 100 may have icons that may operate as touch controls to control the operation of the respective system. The icons for each system may belong to an icon class for that vehicle system. A vehicle system may have two or more classes of icons. The icons related to two or more vehicle systems may be part of the same icon class. Preferably, a user may program (e.g., specify) the icons that are a part of a class or even defined new classes of icons.

In another example embodiment, icons are grouped into classes that are related to the frequency of use of the icons. In this example embodiment, the icon classes include the often-used class, the regularly-used class, the rarely-used class and the never-used class. The definitions of often-used, regularly-used, rarely-used and never-used may include any amount of use during any duration of time. In an example embodiment, the user may set the definition of the amount of use per duration of time. In an example embodiment, often-used icons include those icons that are used at least five times per week. Regularly-used icons include those icons that are used at regular intervals regardless of the length of the interval. Rarely-used icons include those icons that are used at most once every six months. Never-used icons include those icons that have not been used since the manufacture of the vehicle 100 or the last servicing of the vehicle 100.

In another embodiment, the often-used icon class include those icons that are displayed on the touch-sensitive surface 122 of the touchscreen 120/320 and used as a touch control two or more times per week. The regularly-used icon class includes icons that are displayed on the touch-sensitive surface 122 of the touchscreen 120/320 and used as a touch control less than two or more times per week, but at least one time per month. The rarely-used icon class includes icons that are displayed on the touch-sensitive surface 122 of the touchscreen 120/320 and used as a touch control less than one time per month, but at least one time per six months.

Specific touch types may be used to instruct the control system 200/300 to display a specific class of frequency-based icons. In an example embodiment, a first long-downward touch instructs the control system 200/300 to display the icons of the often-used icon class. A second long-downward touch instructs control system 200/300 to display the icons of the regularly-used icon class. A third long-downward touch instructs control system 200/300 to display the icons of the rarely-used icon class. A fourth long-downward touch instructs control system 200/300 to display the icons of the never-used icon class. If any class of the frequency classes of icons cannot be displayed in a single full screen 2110, touch 2322 and/or touch 2332 may be used to page through the additional pages of the class.

In another example embodiment, the various classes of frequency-based icons may be displayed using any four different touch types. For example, touch 1010, touch 1020, touch 820 and touch 920. In another example embodiment, different versions of the 90-degree touch may be used to display the various classes of the frequency-based icons.

### Control Systems

As discussed above, the user may provide input to the control system 200/300 via the touch-sensitive surface 122 to control the various systems of the vehicle 100. In a first example embodiment, the control system 200 includes a processing circuit 250, a memory 260, vehicle systems 210, a touchscreen 120, and a bus 290. The control system 200 may further include a haptic pad 112 and/or a haptic pad 114. The touchscreen 120 of the first example embodiment includes a touch-sensitive surface 122, a display controller 270, a processing circuit 272, a memory 274 and a touch identifier 280. The bus 290 enables the components of the first embodiment of the control system 200 to communicate with each other.

The vehicle systems 210 include the systems of the vehicle 100 that operate to enable the vehicle 100 to perform the functions of the vehicle. In an example embodiment, vehicle systems 210 includes HVAC system 212, infotainment system 214, lights system 216, suspension system 218, communication system 220, seat system 222, stability system 224 and any other system that is used to perform a function of the vehicle 100. The list of vehicle systems given herein does not include all systems that may be a part of vehicle 100.

In the first embodiment, control system 200, the processing circuit 272, the memory 274 and the touch identifier 280 detect contact of a finger or an object with the touch-sensitive surface 122 of the touchscreen 120, identify the touch type (e.g., short touch, short-leftward, so forth), identify any touch control that is been touched, identify the vehicle system associated with any touch control that has been touched, and report the information that has determined to the processing circuit 250. The processing circuit 250, responsive to the information from the touchscreen 120, controls the vehicle system related to touch control that was touched. The processing circuit 250 may also provide status of the vehicle system to the touchscreen 120. The touchscreen 120 may use status information from the processing circuit 250 to provide status information to user via a dynamic touch control displayed on the touch-sensitive surface 122.

The touchscreen 120 of the first embodiment includes sufficient processing power and data to perform most of the functions related to the touchscreen 120, identifying touch types, displaying icon classes, detecting operation of touch controls, managing dynamic touch controls and reporting the operation of a touch control while the processing circuit 250 controls and monitors the vehicle systems 210 in accordance with the information regarding touch controls from the touchscreen 120.

In a second example embodiment, the control system 300 includes the processing circuit 250, the memory 260, the vehicle systems 210, touchscreen 320 and the bus 290. The touchscreen 320 of the second example embodiment includes the touch-sensitive surface 122 and the display controller 270. The control system 300 may further include the haptic pad 112 and/or the haptic pad 114. The bus 290 enables the components of the second embodiment of the control system 300 to communicate with each other.

The processing circuit 250 controls and monitors the vehicle systems 210 in addition to controlling and operating the touchscreen 320. Processing circuit 250 provides information, such as icons, to the touchscreen 320 for display on the touch-sensitive surface 122. The display controller 270 manages the display of objects on the touch-sensitive surface 122. The touchscreen 320 reports the initial location, duration, distance, direction, speed and last location of any touch on the touch-sensitive surface 122. The processing circuit 250 determines the touch type, any icons that may have been touched, any touch controls that may have been operated, any system related to the touch controls, and the function of the system affected by the touch controls. Processing circuit 250 controls and manages the vehicle systems 210 and provides status information regarding the vehicle systems to the touchscreen 320 for display on the touch-sensitive surface 122 via dynamic touch controls.

In either embodiment of the control system, haptic pads 112 and 114 may detect touch information. Because icons cannot be displayed on the haptic pad 112 or 114, the touch information received via the haptic pad 112 or 114 may be related to touch types that instruct the control system 200/300 to take a specific action. As discussed above, specific actions may include establishing or eliminating a sub-area and/or displaying a specific class of icons.

In an example embodiment, a short-rightward touch (e.g., 1422) on haptic pad 112 or 114 instructs the control system 200/300 to establish the sub-area 1420. In another example embodiment, the short-rightward touch on haptic pad 112 or 114 instructs the control system 200/300 to establish the sub-area 1420 into display the passenger class icons 2210 in the sub-area 1420.

In another example, a long-leftward or long-rightward touch (e.g., 2332, 2322 on haptic pad 112 or 114 would instruct the control system 200/300 to successively display icon classes on the touch-sensitive surface 122. For example, assume that the dashboard class 2320 icons are displayed in sub-area 1960. Touch 2322 or touch 2332 on the haptic pad 112 or 114 may be used to show the next class of icons in sub-area 1960. In an example embodiment, touch 2322 may be used scroll from the dashboard class 2320 icons, as shown in FIG. 23, to the HVAC class icons 2420 as shown in FIG. 24. A further touch 2322 scrolls to the information class icons 2240 and so forth to page through all icon classes.

The control system 200/300 may further include mechanical buttons, not shown, or other types of conventional switches (e.g., switches, sliders) for manual operation by a user to provide information to the processing circuit 250. The buttons may be used to control a function of the vehicle. In an example embodiment, the vehicle 100 has a mechanical button for starting the vehicle. The buttons may cooperate with the touchscreen 120/320 to activate or deactivate a function of the vehicle. The buttons may cooperate with the touchscreen 120/320 and/or touch controls displayed on the touch-sensitive surface 122 to provide information regarding performance of a function of the vehicle. One or more mechanical buttons may exclusively control a function of the vehicle, such that the function is not controlled via a touch control presented on the touch-sensitive surface 122. In an example embodiment, activating or deactivating the emergency flashers is exclusively controlled by a mechanical button.

### Memory

A memory (e.g., 260, 274) may store information for use by a processing circuit (e.g., 250, 272) to store icons for vehicle systems, to identify icon classes, to identify icon classes based on frequency, to establish or eliminate sub-areas on the touch-sensitive surface 122, to identify touch types and to map icons for display in the areas of the touch-sensitive surface 122.

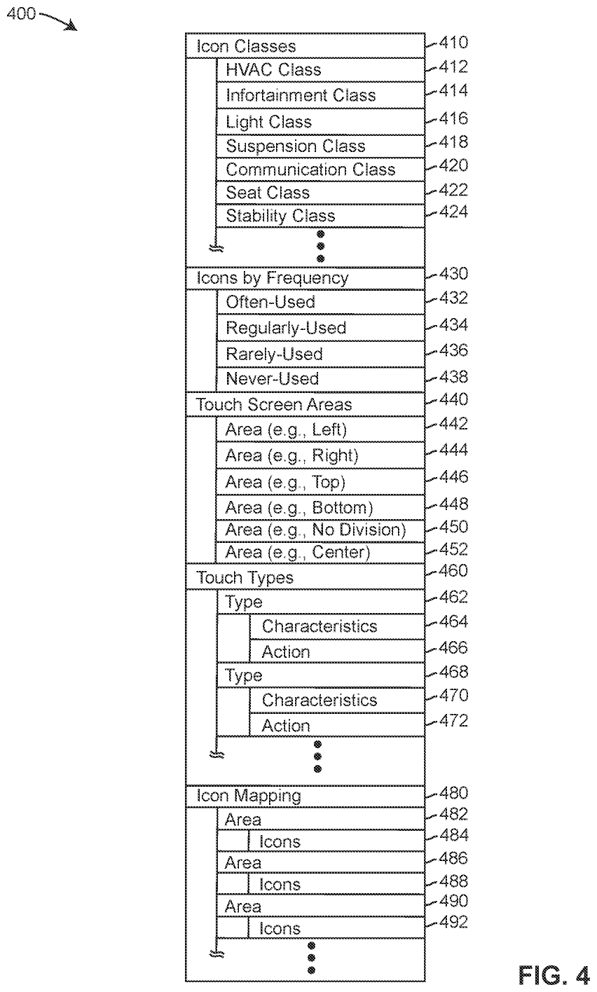

In an example embodiment, the memory (e.g., 260, 274) includes some or all of the data 400 best seen in FIG. 4. Data 400 includes icon classes 410. The data of icon classes 410 categorizes classes of icons with respect to vehicle systems. Icon classes 410 identifies the icons associated with each vehicle system of the vehicle 100. The data of icon classes 410 may store the graphic information related to the icons for the vehicle systems including information for dynamic touch controls. For example, HVAC class 412 includes the information regarding all icons associated with the HVAC system 212. Information may include the operation to be performed, modified, or ceased when the icon operates as a touch control in association with the touch-sensitive surface 122. Infotainment class 414, lights class 416, suspension class 418, communication class 420, seat class 422 and stability class 424 include information related to the icons for the infotainment system 214, the light system 216, the suspension system 218, the communication system 220, the seat system 222 and the stability system 224 respectively.

Icons by frequency 430 groups icons from the various vehicle systems into the often-used, regularly-used, rarely-used and never-used icon classes. Often-used 432 stores information regarding the icons that are often presented on the touch-sensitive surface 122 and used as a touch control. Regularly-used 434 stores information regarding the icons that are regularly presented on the touch-sensitive surface 122 and used as a touch control. Rarely-used 436 stores information regarding the icons that are rarely presented on the touch-sensitive surface 122 and used as a touch control. Never-used 438 stores information regarding the icons that have never been presented on the touch-sensitive surface 122 and used as a touch control. The requirements for categorizing icons with respect to frequency of use are discussed above. Icons by frequency 430 may include some or all of the information from icon classes 410 but grouped and arranged by frequency of use.

Touchscreen areas 440 includes information regarding the sub-areas of the touch-sensitive surface 122. Each area 442, 444, 446, 448, 450 and 452 may include information regarding the location and size of each sub-area. Touchscreen areas 440 may include information regarding the touch type needed to establish or eliminate a particular area. In the examples provided above, information for sub-area 1440, sub-area 1430 and sub-area 1960 would be stored in area 442, area 444, and area 452 respectively. Area 442 may include information that sub-area 1420 is established by touch 1422. Area 444 may include information that sub-area 1430 is established by touch 1432. Touchscreen areas 440 may further include information for each area as to the icon class that should be displayed in the sub-area upon its creation.

Touch types 460 includes information for identifying each type of touch detected by the control system 200/300. Each touch type 462, 468 and so forth include the information needed to identify the touch type. For example, touch type 462 includes characteristics 464 that describes the duration, the direction of movement, the speed of movement and/or the distance of movement of a touch that qualifies to be identified as touch type 462. Touch type 468 includes characteristics 470 that describes the duration, the direction of movement, the speed of movement and/or the distance of movement of a touch that qualifies to be identified as touch type 468. Each touch type that is recognized by control system 200/300 is identified in touch types 460.

Each touch type 462, 468 and so forth further may further include information as to what action should be taken upon detecting the touch type. For example, in one embodiment, action 466 specifies that upon detecting touch type 462 (e.g., touch 1422), the control system 200/300 should create the sub-area 1420 on the touch-sensitive surface 122. In another embodiment, action 466 specifies that upon detecting touch type 462 (e.g., touch 1422), the control system 200/300 should create the sub-area 1420 on the touch-sensitive surface 122 and present the driver class icons 2210 in the sub-area 1420. If no action is to be taken based on touch type alone, action 466 and/or action 472 is omitted or left empty for a particular touch type.

Icon mapping 480 stores information as to the icons that should be displayed on the touch-sensitive surface 122 in a particular sub-area. For example, area 482, area 486 and area 490 specify a specific sub-area, or full-area 2110, of the touch-sensitive surface 122. The icons identified in icons 484, icons 488 and icons 492 should be displayed in the area 482, 486 and 490 respectively. The information in icons 484, icons 488 and icons 492 may include some or all of the information in icon classes 410 and/or icons by frequency 430. The icons for area 482, 486 and 490 may be changed and/or updated at any time to display any icon in any area when needed.

The data 400 is not limited to the examples of data identified herein. Data 400 may include any data needed to display icons, to detect touch types, to detect the operation of touch controls, to perform a function responsive to a touch control, and/or to control dynamic touch controls.

### Dynamic Touch Controls

As discussed above, an icon, and thereby a touch control, may be static or dynamic. The image of a static touch control does not change. Whether touched or untouched, the image of a static touch control remains the same all the time. A static touch control does not provide status information regarding the function of the vehicle system associated with the static touch control. In an example embodiment, referring to FIG. 21, touch control 2140 for the ride height of the vehicle 100 is a static touch control. If the user activates the up arrow of the touch control 2140 to increase the height of the ride, the image of the touch control 2140 does not change. The user can detect the change in the ride height through feeling movement of the vehicle 100 or visually.

Other touch controls may be dynamic. For example, referring to FIG. 22, the touch controls 2230 and 2232 are dynamic touch controls that cooperate with each other. When the headlights are turned on and the high beams are enabled, the touch control 2230 is highlighted (e.g., lit, green color) to show that the high beams are enabled and the touch control 2232 is not highlighted. When touch control 2232 is touched to enable the low beams, the touch control 2232 is highlighted and the touch control 2230 changes so that it is no longer highlighted. Highlighting touch control 2232 shows that the low beams are enabled and removing the highlight from the touch control 2230 shows that the high beams are not enabled. Highlighting a touch control to show that the function related to the touch control is active is only one way of providing status information to a user.

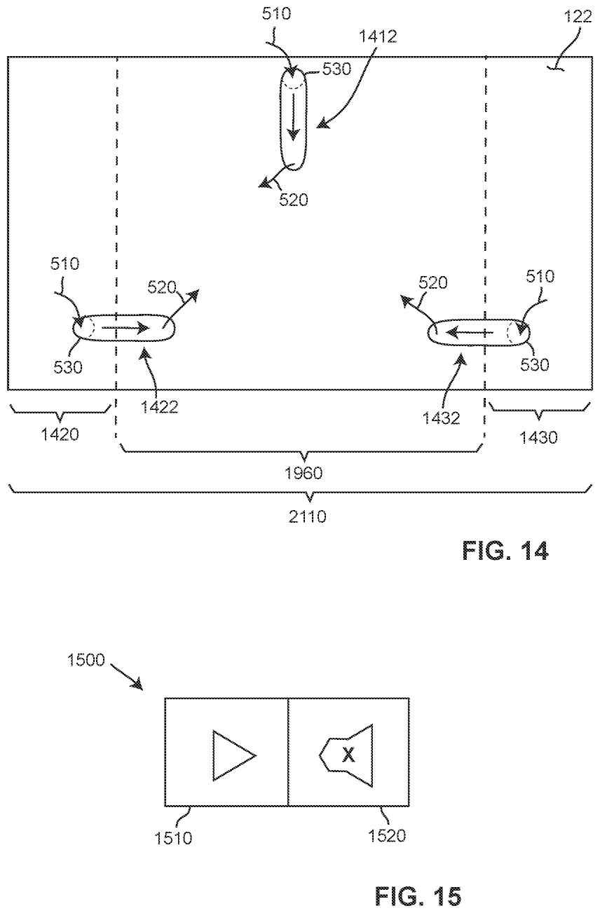

In another example of a dynamic touch control, referring to image 1500 of FIG. 15, touch control 1510 may be used to control playback from the infotainment system 214. The touch control 1510 may be touched the start playback of some type of media (e.g., radio, podcast, CD). The touch control 1520 may be touched to mute or unmute the speakers that are playing back the media. When touch control 1510 is touched with a short touch (see FIG. 5), the image 1500 changes to image 1600, as best seen in FIG. 16. In image 1600, the touch control 1510 has changed from the play symbol to the pause symbol, so that playback of the media may be paused upon touching the touch control 1630. Touch control 1520 remains the same to permit muting and unmuting of the speakers.

However, image 1600 is dynamic in that image 1600 provides information regarding the media being played. In this example, area 1610 of image 1600 provides the title of the song being played and the name of the group performing the song. Further, in area 1620, information regarding the elapsed time of playback and the total time of the song is provided. So, image 1500 is a dynamic touch control that when activated changes to image 1600 to provide information regarding the status of playback.

In another example, referring to FIG. 17, image 1700 includes touch control 1710 which activates cellular telephone communication via the hands-free system installed in the vehicle 100. In this example, when an incoming phone call arrives, the communication system 220 notifies the user by causing a ringing sound. If the user desires to receive the incoming call, the user touches touch control 1710 to pick up the call. Upon touching touch control 1710, the image 1700 changes to image 1800.

The image 1800 not only provides information regarding the caller and the duration of the call in area 1840, but also provides additional touch controls 1810, 1820 and 1830 to provide further control over the communication system 220. The touch control 1810, when selected, terminates the phone call. When touch control 1810 is activated, the call is terminated and image 1800 is replaced with image 1700.

The touch control 1820 enables the user to mute and unmute the microphone of the hands-free system while talking on the phone. The touch control 1820 may also be a dynamic touch control in that when the microphone is muted, touch control 1820 is highlighted. When the microphone is not muted, touch control 1820 is not highlighted. Touch control 1830 may be used to mute the speaker that enables the user to hear the caller. When the touch control 1820 or 1830 is activated, it is highlighted to show that muting is on. When touch control 1820 or 1830 is not active, it is not highlighted to show that muting is off.

The status information of the call that is shown in area 1840 of the image 1800 is displayed until the call is terminated by touching touch control 1810. Additional call information that may be displayed in area 1840 may include cellular phone signal strength, cellular phone battery level and/or time of day.

As shown in these two examples, the image of a dynamic touch control is different before activation and after activation. The different images may be different in size and may require more or less area for display on the touch-sensitive surface 122. For example, the area of the image 1500 on the touch-sensitive surface 122 is less than the area of the image 1600. Further, the area of the image 1700 is less than the area of the image 1800. The display of the touch controls on the touch-sensitive surface 122 may be adjusted as the area of the image of dynamic touch controls changes (e.g., increases, decreases).

### Programmability

The control system 200/300 may be, to some extent, programmable by a user. As discussed above, programmability may include identifying the criteria for categorizing touch controls as often-used, regularly-used or rarely-used. For example, a user may specify that often-used touch controls are used daily, regularly-used touch controls are used at least once a week and rarely-used touch controls are used at most once a month.

Programmability may further enable the user to organize icons into specific groups. For example, a user may specify the icons that are associated with the driver class icons and/or passenger class icons. Further, a user may specify that certain icons of a vehicle system class not be displayed because the user has no intention of using those icons as touch controls. Further, the user may specify specific icons as being part of the favorites class of icons. A user may further group icons according to different users of the vehicle 100.

Another aspect of programmability may include allowing the user to specify the status information that is displayed by a dynamic touch control. For example, referring to FIG. 18, a user may specify that the information displayed in area 1840 include the battery level of the cell phone. In another aspect, programmability may enable the user to select from a variety of images for a particular icon or touch control. The user may change the color and/or size of an icon.

In another aspect of programmability, the user may specify the size and placement of the sub-areas of the touch-sensitive surface 122. Further, the user may specify the touch type that establishes or eliminates sub-areas. Further, the user may specify the touch type for any action that may be performed by the control system 200/300. The user may specify the touch controls that are displayed when the control system 200/300 is initialized (e.g., startup class 1910) at the starting of the vehicle 100. The user may specify which touch controls appear together on a screen. Any aspect of the operation of the touch control system 200/300 may be programmable by a user especially with respect to how touch controls are displayed, the actions associated with a particular touch type or the content of an icon class.

### In Operation

While the vehicle 100 is not in its operational mode (e.g., turned on, running) many if not most of the vehicle systems 210 are not operating and may even be powered down. Some vehicle systems are powered up and operational. For example, in an example embodiment, while the vehicle is not operational, the locking system, not shown, is active to receive signals from a remote controller (e.g., key FOB) to lock or unlock the doors. Processing circuit 250 and memory 260 may be in an operational state or in a low-power operational state to be able to control and/or monitor those vehicle systems that are enabled and powered up.

While the vehicle 100 is not in its operational mode, the touchscreen 120/320 is likely powered down or in a low power state. In the example embodiment, the touchscreen 120/320 is powered down and no information is displayed on the touch-sensitive surface 122.

The vehicle 100 transitions from the non-operational mode to the operational mode in any manner. In an example embodiment, the locking system detects the proximity of the remote controller, and the user activates a mechanical button to cause the vehicle 100 to enter the operational mode. In another example embodiment, the locking system detects the insertion of a key into an ignition and as a result enters the operational mode. Upon entering the operational mode, the control system 200/300 is powered and fully enabled. In another example embodiment, while the vehicle 100 is in the non-operational mode, the touchscreen 120/320 is active and displays icon 1920 with lock touch control 1922 and unlock touch control 1924 so that the doors may be locked and unlocked without the vehicle 100 entering the operational mode.

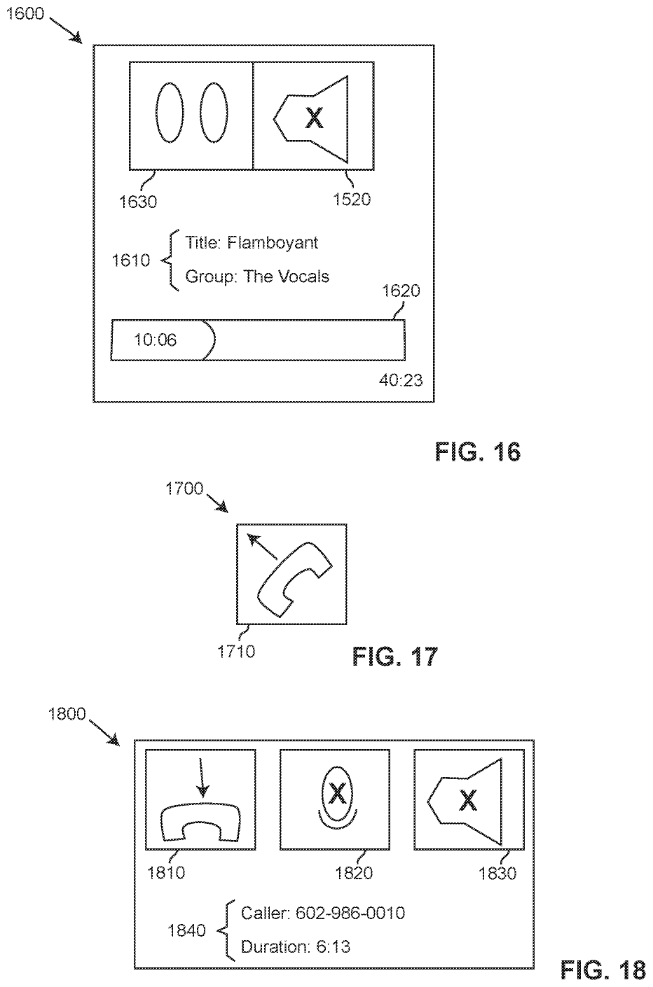

In the example embodiment, upon entering the operational mode, as best shown in FIG. 19, the control system 200/300, enables the touchscreen 120/320, establishes sub-area 1420 and displays the startup class 1910 of icons in the sub-area 1420. The icons that belong to the startup class 1910 may be programmed by the user. In the example embodiment, the startup class 1910 includes a door lock touch control 1920, a touch control 1930 for accessing the dashboard class 2320 icons, a touch control 1940 for accessing the infotainment class icons, and touch control 1950 for accessing a settings class icons. Touching (e.g., short touch) the touch control 1922 locks the doors of the vehicle 100. Touching the touch control 1924 unlocks the doors of the vehicle 100. Touching the touch control 1930, 1940 or 1950 causes the control system 200/300 to display dashboard class 2320 icons, infotainment class icons (not shown) or settings class icons (not shown) respectively on the touch-sensitive surface 122. The icons as displayed on the touch-sensitive surface 122 operate as touch controls related to the various classes of the vehicle systems. The icon classes may be presented in the sub-area 1960 or the sub-area 1420 may be eliminated and the icons displayed on the full-screen area 2110.

In the example embodiment, instead of touching one of the touch controls 1920-1950, referring to FIGS. 20-21, the user may use touch 2010, which is a long-downward touch, to instruct the control system 200/300 to display one or more icon classes on the full area 2110. In the example embodiment, touch 2010 results in displaying the wiper 2160, regeneration 2162, ride control 2164 and light 2166 icon classes on the touch-sensitive surface 122. The icon classes that are displayed may be programmed by the user. From the screen shown in FIG. 21, the user may touch any of the displayed touch controls to control the system associated with the touch control. For example, the user could touch (e.g., short touch) touch control 2130 to activate/deactivate descent assist. The user could use touch control 2150 to activate/deactivate the light in the front trunk (e.g., frunk).

The user may also use the touch 2322 and/or the touch 2332 to page (e.g., flip, scroll) through the icon classes for the various vehicle systems and/or the icon classes based on frequency of use. For each use of the touch 2322 or 2332, the control system 200/300 presents one or more different classes of icons on the touch-sensitive surface 122. When the user has found the icon class of interest, the user may use the touch controls of that class to control the associated vehicle system. At any time, the user may use touch 1422 to create sub-area 1420 to display the driver class icons 2210 or touch 1432 to create sub-area 1430 to display the passenger class icons 2310.

Another example class of icons that may be displayed, as best seen in FIG. 22, is the information class 2240 icons. Many, if not all, of the icons of the information class 2240 provide information and thereby function as dynamic touch controls. For example, messages 2242 provide information as to the messages (e.g., text messages, voice) that have arrived via the communication system 220. Touching any one of the message touch controls displays or plays the message. Schedule 2244 displays information regarding the user's schedule. Touching any one of the schedule items provides information regarding the item. Reminders 2246 may be touched to modify or deactivate the reminder. Weather 2248 may be touched to receive more detailed information with respect to the weather.

Not all icons displayed as part of the information class 2240 are dynamic touch controls, but rather dynamic icons. For example, vehicle status 2250 presents information regarding the status of the operation of the vehicle 100 but touching any the icons of vehicle status 2250 does not result in an action. In other words, vehicle status 2250 merely presents information, even though it is updated periodically, rather than functioning as a touch control. The user would need to navigate to the appropriate vehicle system page to modify the operation of the vehicle 100. Further, the navigation status 2252 may be dynamic icons that provide information rather than dynamic touch controls.

### Methods

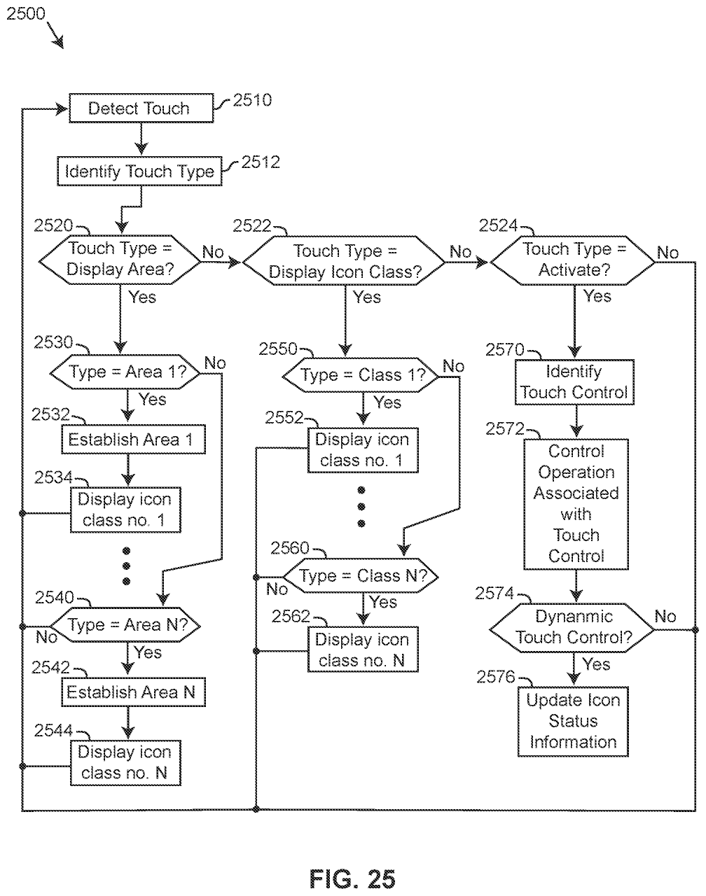

An example embodiment of a method is shown in FIG. 25. The example embodiment, the method 2500, is performed by the control system 200/300 to perform the functions of the control system 200/300. The processing circuit 250 may execute a stored program to perform the example embodiment method 2500. The example embodiment method 2500 includes detect 2510, identify 2512, area 2520, icon 2522, activate 2524, area 2530, establish 2532, display tray 534, area 2540, establish 2542, display 2544, class 2550, display 2552, class 2560, display 2562, identify 2570, activate 2572, dynamic 2574 and update 2576.

Detect 2510 detects contact of a finger or an object with the touch-sensitive surface 122 of the touchscreen 120/320. Detect 2510 detects the initial location of contact of the finger or object with the touch-sensitive surface 122. Detect 2510 determines the duration of time of contact of the finger or object with the touch-sensitive surface 122. Detect 2510 detects the direction of movement of the finger or object along the touch-sensitive surface 122. Detect 2510 detects the speed of movement of the finger or object along the touch-sensitive surface 122. Detect 2510 detects the distance of movement of the finger or object along the touch-sensitive surface 122. Detective 2510 detects the last location of contact of the finger or object with the touch-sensitive surface 122. Detect 2510 may record (e.g., save, store) the information detected. As discussed above, detect 2510 may be performed by processing circuit 272 and/or processing circuit 250 of the control system 200 or processing circuit 250 of the control system 300. The touchscreen 120/320 may provide information for determining the above.

Detect 2510 may also detect whether the finger or object came into contact with a touch control. Detect 2510 may determine the specific touch control or touch controls contacted by the finger or object, the location of contact on the touch control and/or the area or portion of the touch control contacted by the finger or object. Detective 2510 may report the touch control contacted by the finger or object so that the control system 200/300 may determine whether the touch should result in control of a vehicle system. Although detect 2510 does not control activation/deactivation of the vehicle systems, it provides the information so that it may be determined whether a vehicle system should be activated, deactivated and/or adjusted (e.g., controlled).

Identify 2512 uses the information detected by detect 2510 to determine the touch type of the contact (e.g., touch) of the finger or object with the touch-sensitive surface 122. As discussed above, touch identifier 280 of the control system 200 may determine the touch type. Processing circuit 250 of the control system 300 may determine the touch type. Touch identifier 280 may use information from the memory 274 to identify the touch type. The processing circuit 250 may use information from the memory 260 to identify the touch type. As further discussed above, touch types may include a plurality of touch types.

Area 2520, icon 2522 and activate 2524 identify a specific touch type and take action responsive to a specific touch type. Area 2520 identifies one or more touch types used to establish a sub-area on the touch-sensitive surface 122. For example, touch 1422, a short-rightward touch, and touch 1432, a short-leftward touch, establish sub-area 1420 and sub-area 1430 respectively. Touch 2010, a long-downward touch, eliminates all sub-areas so information may be displayed on the full area 2110. Each time area 2520 identifies the touch type as a touch that establishes an area on the touch-sensitive surface 122, control moves to 2530.

Icon 2522 identifies one or more touch types used to display an icon class. In an example embodiment, touch 1110, which resembles the letter P, instructs the control system 200/300 to display the passenger class icons on the touch-sensitive surface 122. In another example embodiment, the touch 1010 (e.g., letter V) and the touch 1020 (e.g., chevron symbol), instructs the control system 200/300 to display the driver class icons and the passenger class icons respectively. Each time icon 2522 identifies the touch type as a touch that displays a class of icons, control moves to 2550.

Activate 2524 identifies one or more touch types used to activate/deactivate a touch control. For example, short touch 550 may be used activate a touch control. For example, a short touch on touch control 1510 will cause the infotainment system 214 to play media. A short touch on touch control 1520 will mute or unmute the speaker of the infotainment system 214. In another example, a touch in a direction along a slider, for example, slider 1310 in FIG. 13, may be used to control the slider. Each time activate 2524 identifies a touch type that may be used to activate/deactivate a touch control, control moves to 2570.

Once area 2520 has identified a touch type that relates to establishing or eliminating a sub-area, the touch type must be further categorized to determine which sub-area should be established or eliminated. Area 2530 and area 2540 relate a specific touch type to a specific sub-area. Area 2530 represents identifying a first specific touch type. Area 2540 represents identifying an Nth specific touch type. There may be any number of area 2530/2440 steps for identifying any number of specific touches for establishing or eliminating any number of sub-areas.

Area 2530 determines whether the touch type identified in area 2520 is the specific touch type for establishing sub-area no. 1. If the touch type is the specific touch type for establishing sub-area no. 1, establish 2532 is executed to establish the sub-area no. 1. After the sub-area no. 1 is established, display 2534 may be executed to display the icons of icon class no. 1 in sub-area no. 1. Display 2534 is optional. If display 2534 is not included, execution moves from establish 2532 to detected 2510. If display 2534 is included, execution moves from display 2534 to detect 2510. If the touch type is not a specific touch type for establishing sub-area no. 1, control moves to area 2540.

Area 2540 determines whether the touch type is the specific touch type for establishing sub-area no. N. If the touch type is the specific touch type for establishing sub-area no. N, establish 2542 is executed to establish the sub area no. N. After the sub-area no. N is established, display 2544 may be executed to display the icons of icon class no. N in sub-area no. N. As discussed above with respect to display 2534, display 2544 is optional.

In an example embodiment, touch 1422, a short-rightward touch, indicates that sub-area 1420 should be created and that the driver class icons should be displayed in the sub-area 1420. Area 2530 could recognize touch 1422, establish 2532 would establish sub-area 1420 and display 2534 would display the driver class icons in the sub-area 1420.

Blocks 2530-2534 and 2540-2544 do not show steps for eliminating one or more areas; however, execution of a block for eliminating one or more areas upon recognizing a specific touch type could be added.

Once icon 2522 identifies a touch type related to displaying icons of a particular class, the specific touch type must be identified to determine which class of icons should be displayed. Class 2550 and class 2560 identify specific touch types. Class 2550 determines whether the touch type identified in icon 2522 matches the specific touch type for displaying class no. 1 icons. Class 2560 determines whether the touch type matches the specific touch type for displaying class no. N icons. There may be any number of steps similar to class 2550 or class 2560 for identifying any number of specific touch types related to displaying a specific class of icons.

Once class 2550 has determined that the touch type identified by icon 2522 is the specific touch type for displaying the icons of icon class no. 1, execution moves to display 2552 which displays the icons of icon class no. 1 on the touch-sensitive surface 122. If class 2550 determines that the touch type identified by icon 2522 is not the specific touch type for displaying the icons of icon class no. 1, execution moves to class 2560 for further testing of the touch type.

If class 2560 determines that the touch type identified by icon 2522 is the specific touch type to display the icons of icon class no. N, execution moves to display 2562 which displays the icons of icon class no. N on the touch-sensitive surface 122. If class 2560 determines that the touch type is not the specific touch type to display the icons of icon class no. N, execution moves to detected 2510.

There may be as many class 2550 or class 2560 blocks as needed to identify all of the touch types that should result in the displaying the icons of a class. For example, class 2550 may identify touch 1110 (see FIG. 11) while class 2560 may identify touch 1010 (see FIG. 10B), and another class block may identify touch 1020 (see FIG. 10B).

Once activate 2524 detects a touch type used to activate/deactivate a touch control, identify 2570 is used to determine the touch control that has been touched. As discussed above, detect 2510 may determine which touch control displayed on touch-sensitive surface 122 was contacted by the finger or object. This information may be reported to identify 2570. Knowing which touch control was touched may include such information as the vehicle system related to the touch control, the operation of the vehicle system related to the touch control, and the action to be taken by the vehicle system as a result of touching the touch control. In another example embodiment, identify 2570 may determine which touch control was touched and the further information discussed above.

Activate 2572 uses the information determined by identify 2570 to control the vehicle system related to the touch control in the manner specified by the touch control. Activate 2572 may take such actions as activating, deactivating, changing the operation of, and/or adjusting the operation of the vehicle system related to the touch control.

Dynamic 2574 determines whether the touch control is a dynamic touch control. If the touch control is a dynamic touch control, update 2576 is executed to update the image of the icon of the touch control. If the touch control is not a dynamic touch control, control moves to detected 2510.

### Afterword

The foregoing description discusses various embodiments, which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A control system for a vehicle, the control system comprising:
a processing circuit;
a memory, the memory stores an information regarding a plurality of icon classes and regarding a plurality of touch types;
a plurality of vehicle systems; and
a touchscreen having a touch-sensitive surface; wherein:
the processing circuit is adapted to detect at least one of an initial location of contact, a duration, a direction of movement, a speed of movement, a distance of movement and a last location of contact of a first touch between an object and the touch-sensitive surface of the touchscreen to identify a first touch type of the first touch in accordance with the information regarding the plurality of touch types;
the processing circuit is adapted to correlate the first touch to an icon displayed on the touchscreen; and
responsive to at least one of identifying the first touch type and correlating the first touch to the icon displayed on the touchscreen, the processing circuit is adapted to perform at least one of instruct one or more of the plurality of vehicle systems to perform an operation and display a first icon class of the plurality of icon classes on the touchscreen.

2. The control system of claim 1 wherein each icon class of the plurality of icon classes relates to one vehicle system of the plurality of vehicle systems respectively.

3. The control system of claim 1 wherein the plurality of icon classes comprises icons grouped by a frequency of use. The

4. The control system of claim 3 wherein the frequency of use comprises an often-used class, a regularly-used class, a rarely-used class and a never-used class.

5. The control system of claim 1 wherein the processing circuit is adapted to use the information regarding the plurality of touch types to identify the first touch type of the first touch.

6. A control system for a vehicle, the control system comprising:
a processing circuit;
a memory, the memory stores an information regarding a plurality of icon classes and regarding a plurality of touch types;
a plurality of vehicle systems; and
a touchscreen having a touch-sensitive surface; wherein:
the processing circuit is adapted to detect at least one of an initial location of contact, a duration, a direction of movement, a speed of movement, a distance of movement and a last location of contact of a touch between an object and the touch-sensitive surface of the touchscreen to identify a touch type of the touch in accordance with the information regarding the plurality of touch types;
responsive to identifying a first touch type, the processing circuit is adapted to display a driver class of icons on the touchscreen; and
responsive to identifying a second touch type, the processing circuit is adapted to display a passenger class of icons on the touchscreen.

7. The control system of claim 6 wherein the first touch type comprises a short touch in a rightward direction.

8. The control system of claim 6 wherein the driver class of icons comprises icons that are useful primarily to a driver of the vehicle.

9. The control system of claim 6 wherein the second touch type comprises a short touch in a leftward direction.

10. The control system of claim 6 wherein the passenger class of icons comprises icons that are useful primarily to a passenger of the vehicle.

11. The control system of claim 6 wherein responsive to identifying a third touch type, the processing circuit is adapted to display an often-used class of icons that includes icons that are displayed on the touchscreen and used as a touch control two or more times per month.

12. The control system of claim 6 wherein responsive to identifying a fourth touch type, the processing circuit is adapted to display a regularly-used class of icons that includes icons that are displayed on the touchscreen and used as a touch control at most one time per month.

13. The control system of claim 6 wherein responsive to identifying a fifth touch type, the processing circuit is adapted to display a rarely-used class of icons that includes icons that are displayed on the touchscreen and used as a touch control at most one time per six months.

14. The control system of claim 6 wherein responsive to identifying the first touch type, the processing circuit is further adapted to:
establish a first sub-area of the touch-sensitive surface of the touchscreen; and
display the driver class of icons of the plurality of icon classes in the first sub-area.

15. The control system of claim 14 wherein responsive to identifying the second touch type, the processing circuit is further adapted to:
establish a second sub-area of the touch-sensitive surface of the touchscreen; and
display the passenger class of icons of the plurality of icon classes in the second sub-area.

16. The control system of claim 15 wherein responsive to identifying a sixth touch type, the processing circuit is adapted to display a first class of icons of the plurality of icon classes in a third sub-area of the touch-sensitive surface of the touchscreen that excludes the first sub-area and the second sub-area.

17. The control system of claim 16 wherein each time the processing circuit identifies the sixth touch type, the processing circuit is adapted to display another class other icons of the plurality of icon classes in the third sub-area.

18. The control system of claim 16 wherein the sixth touch type comprises a long touch in a rightward direction or the long touch in a leftward direction.

19. The control system of claim 16 responsive to identifying a seventh touch type, the processing circuit is adapted to:
eliminate the first sub-area and the second sub-areas if established; and
display a second class of icons of the plurality of icon classes in a whole of the touch-sensitive surface of the touchscreen.

20. The control system of claim 19 wherein the seventh touch type comprises a short touch in a downward direction.
